(19) United States
(12) Patent Application Publication
(10) Pub. No.: US 2025/0267373 A1
(43) Pub. Date: Aug. 21, 2025

(54) ACCESSORY APPARATUS, IMAGE PICKUP SYSTEM, CONTROL METHOD OF ACCESSORY APPARATUS, AND STORAGE MEDIUM

(71) Applicant: CANON KABUSHIKI KAISHA, Tokyo (JP)

(72) Inventor: TAKESHI YONEZAWA, Tochigi (JP)

(21) Appl. No.: 19/043,983

(22) Filed: Feb. 3, 2025

(30) Foreign Application Priority Data
Feb. 19, 2024 (JP) 2024-022893

(51) Int. Cl. H04N 23/84; G03B 17/14; H04N 23/55

(52) U.S. Cl. CPC H04N 23/84; G03B 17/14; H04N 23/55

(57) ABSTRACT

An accessory apparatus detachably attached to an image pickup apparatus includes a processor that performs a first process and a second process in communicating with an external device, a first storage unit, and a second storage unit having a readout speed lower than a readout speed of the first storage unit. The first storage unit stores first optical data related to the first process, and the second storage unit stores second optical data related to the second process.

### BACKGROUND

### Technical Field

The present disclosure relates to an accessory apparatus, an image pickup system, a control method of an accessory apparatus, and storage medium.

### Description of Related Art

Conventionally, an apparatus has been known which corrects a part of image degradation caused by an optical system. Japanese Patent Laid-Open No. 2006-135805 discloses an apparatus which calculates an amount of chromatic aberration on an image pickup plane and corrects image degradation caused by the chromatic aberration. Japanese Patent Laid-Open No. 2005-217504 discloses an apparatus which corrects a falling of peripheral illumination by amplifying an image signal.

In order to correct a high-definition image with high accuracy, an amount of optical data (correction data) used for the correction increases. The optical data is stored, for example, in a storage unit (an ROM area) in a lens control unit which controls a lens apparatus (an accessory apparatus). However, an amount of data which can be stored in the storage unit is limited.

### SUMMARY

An accessory apparatus according to one aspect of the present disclosure is detachably attached to an image pickup apparatus, and the accessory apparatus includes a processor configured to perform a first process and a second process in communicating with an external device, a first storage unit, and a second storage unit having a readout speed lower than a readout speed of the first storage unit. The first storage unit stores first optical data related to the first process, and the second storage unit stores second optical data related to the second process.

Further features of the disclosure will become apparent from the following description of embodiments with reference to the attached drawings.

### BRIEF DESCRIPTION OF THE DRAWINGS

FIG. 1 is a block diagram of an image pickup system according to a first embodiment.

FIG. 2 explains optical data according to the first embodiment.

FIG. 3 explains an interpolation calculation of the optical data according to the first embodiment.

FIG. 4 is a flowchart which illustrates an operation of a first data processing unit according to the first embodiment.

FIG. 5 is a flowchart which illustrates an operation of a second data processing unit according to the first embodiment.

FIG. 6 is a flowchart which illustrates a process of a camera body according to the first embodiment.

FIG. 7 is a block diagram of an image pickup system according to a second embodiment.

FIG. 8 explains optical data according to the second embodiment.

FIG. 9 is a flowchart which illustrates an operation of a second data processing unit according to the second embodiment.

FIG. 10 explains a modification of the second embodiment.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of each embodiment according to the disclosure.

### First Embodiment

The first embodiment relates to an image pickup system 100 equipped with an accessory apparatus. In this embodiment, the accessory apparatus will be described as a lens apparatus (an interchangeable lens) which is detachably attachable to an image pickup apparatus (a camera body). However, this embodiment is not limited to this, and can also be applied to other accessory apparatuses such as an extender which is detachably attachable between the image pickup apparatus and the lens apparatus. In addition, in this embodiment, an appropriate method of arranging optical data in the lens apparatus of the image pickup system 100 is described, in which a peripheral illumination correction calculates a correction value corresponding to a current position in the lens apparatus, and a chromatic aberration correction calculates a correction value corresponding to a current position in the image pickup apparatus. However, this embodiment is not limited to this, and can be applied to other optical data. These points also apply to the embodiment described below.

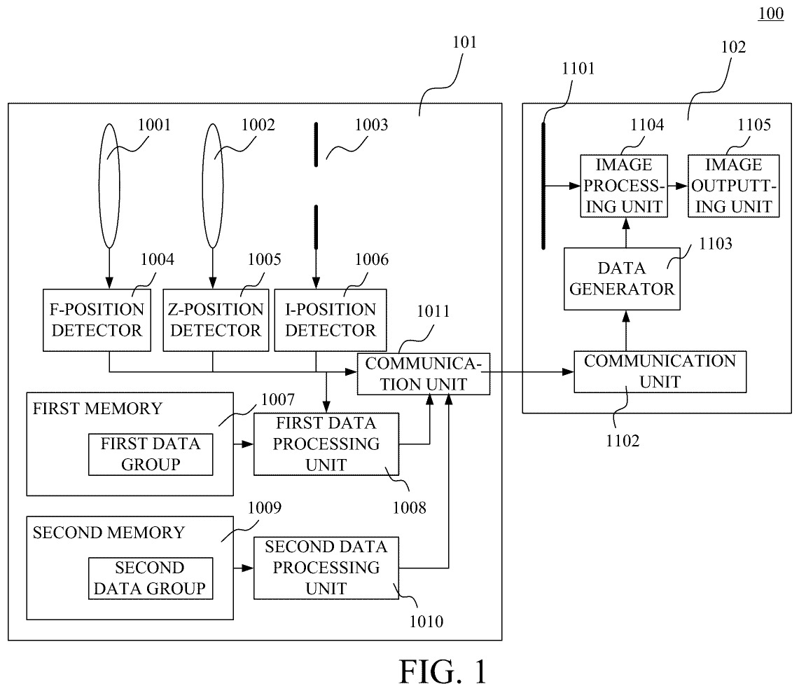

First, the image pickup system 100 according to this embodiment will be described with reference to FIG. 1. FIG. 1 is a block diagram of the image pickup system 100. The image pickup system 100 includes a camera body (an image pickup apparatus) 102 and a lens apparatus (an interchangeable lens, an accessory apparatus) 101 which is detachably attachable to the camera body 102. However, this embodiment is not limited to this, and can also be applied to an image pickup apparatus in which a camera body and a lens apparatus are integrally configured.

The lens apparatus 101 forms an image of an object on an image sensor 1101 in the camera body 102 via a focus lens 1001, a zoom lens 1002, and a diaphragm (an aperture stop) 1003. Each of the focus lens 1001, the zoom lens 1002, and the diaphragm 1003 constitutes a movable optical member in this embodiment.

An F-position detector 1004, a Z-position detector 1005, and an I-position detector 1006 are position detectors which detect positions of the focus lens 1001, the zoom lens 1002, and the diaphragm 1003, respectively, and include, for example, a potentiometer or an encoder.

A first memory (a first storage unit) 1007 and a second memory (a second storage unit) 1009 store optical data. The first memory 1007 stores first optical data which is related to a first process, and the second memory 1009 stores second optical data which is related to a second process. For example, the first process is a process which is performed in a case where a state of the lens apparatus 101 has not been changed, and the second process is a process which is performed in a case where a state of the lens apparatus 101 has been changed. In other words, the first process is a process which is performed periodically, and the second process is a process which is performed in response to a user's operation (a process which is not a periodic process). Preferably, the second process is an initialization process for the lens apparatus 101. Also preferably, the first process is a process of communicating with an external device at a first communication speed, and the second process is a process of communicating with an external device at a second communication speed which is lower than the first communication speed.

Preferably, the first process is a process for calculating optical data corresponding to a current position using at least a part of the first optical data and transmitting the calculated optical data to an external device, and the second process is a process for transmitting the second optical data to an external device. More preferably, the second optical data is focal length information, angle-of-view information, field-of-view information, object distance information, focus sensitivity information, entrance pupil position information, or exit pupil position information. In addition, preferably, the second optical data is peripheral illumination correction information, chromatic aberration correction information, distortion aberration correction information, breathing correction information due to focus change, correction information for image restoration, or focus correction information. Also preferably, the second optical data includes at least one of the above-mentioned pieces of information.

Compared to the second memory 1009, the first memory 1007 allows data to be read out at high speed from a lens CPU (Central Processing Unit) which performs a lens control. In this embodiment, the first memory 1007 is a ROM (Read Only Memory) area within a one-chip microcomputer, but is not limited to this.

The second memory 1009 is slower in reading out data from the lens CPU which performs the lens control than the first memory 1007 (a readout speed of the second memory 1009 is lower than that of the first memory 1007). In this embodiment, the second memory 1009 is, for example, a flash memory IC which is separately configured outside the microcomputer, but is not limited to this. When reading out data from the flash memory IC, it is necessary to specify a beginning address of the data to be read out via a serial communication and a size of the data to be read out via the serial communication, and then read the data.

In this embodiment, the optical data includes a first data group and a second data group. The first memory 1007 stores the first data group. The second memory 1009 stores the second data group. This is because a capacity of a storage area of the first memory 1007 is not sufficient to store both the first data group and the second data group (i.e., all of the optical data) in the first memory 1007. The first data group and the second data group will be described in detail later.

A first data processing unit 1008 and a second data processing unit 1010 are data processing units which perform the first process and the second process during communication, respectively. The first data processing unit 1008 generates correction data to be notified to the camera body 102 in accordance with positions detected by the F-position detector 1004, the Z-position detector 1005, and the I-position detector 1006, based on, for example, the first data group stored in the first memory 1007. The first data processing unit 1008 will be described in detail later. The second data processing unit 1010 generates correction data to be notified to the camera body 102 based on, for example, the second data group stored in the second memory 1009. The second data processing unit 1010 will be described in detail later.

A communication unit 1011 communicates with an external device such as the camera body 102, and transmits information to and receives information from the external device. In this embodiment, the communication unit 1011 communicates the correction data generated by the first data processing unit 1008 and the second data processing unit 1010 in addition to the detected positions from the F-position detector 1004, the Z-position detector 1005, and the I-position detector 1006. The external device is not limited to the camera body 102, but may be another accessory apparatus.

The camera body 102 performs image processing such as a peripheral illumination correction or a chromatic aberration correction on an image captured by the image sensor 1101 using the correction data output from the communication unit 1011 of the lens apparatus 101. A communication unit 1102 communicates the correction data and the like with the communication unit 1011 of the lens apparatus 101. A data generator 1103 generates data for performing the image processing such as the peripheral illumination correction or the chromatic aberration correction based on the detected position of each optical member and the correction data acquired via the communication unit 1102. A data generation by the data generator 1103 will be described in detail later.

An image processing unit 1104 performs the image processing such as the peripheral illumination correction or the chromatic aberration correction based on the data generated by the data generator 1103. An image outputting unit 1105 outputs an image generated by the image processing unit 1104. The image outputting unit 1105 is, for example, an output unit to an attached monitor, an external memory such as an SD card, or an HDMI (registered trademark) output terminal.

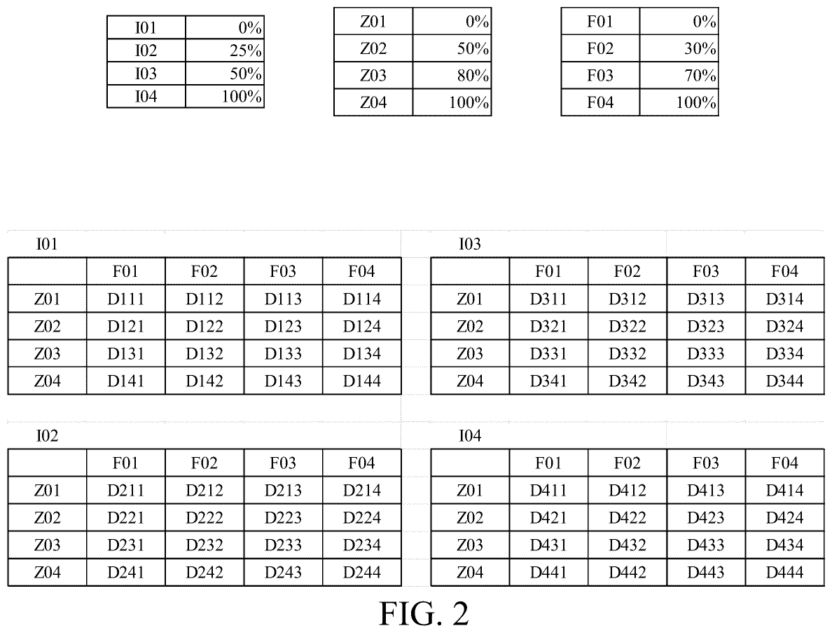

Next, the optical data (the first data group and the second data group) will be described in detail with reference to FIG. 2. FIG. 2 explains the optical data. The first data group has a three-dimensional table structure corresponding to the respective positions of the focus lens 1001, the zoom lens 1002, and the diaphragm 1003. In this embodiment, the first data group is described as peripheral illumination correction data for correcting the falling of peripheral illumination, but is not limited to this.

The upper left diagram in FIG. 2 is a table which illustrates positions of the diaphragm 1003. In the upper left diagram of FIG. 2, the positions of the diaphragm 1003 at indexes I01 to I04 are illustrated as percentages when a movable range of the diaphragm 1003 is set to 100% and an open end is set to 0%. Similarly, the upper middle diagram in FIG. 2 illustrates zoom positions when a wide-angle end is set to 0%. The upper right diagram in FIG. 2 illustrates focus positions when a closest end is set to 0%.

The lower diagram in FIG. 2 illustrates the peripheral illumination correction data corresponding to the respective positions of the focus lens 1001, the zoom lens 1002, and the diaphragm 1003. For example, the peripheral illumination correction data at the position of I01, Z02, and F03 is D123. The peripheral illumination correction data at each position is a ratio of a light amount at each position to a center of a screen at multiple image heights, and is data that makes it possible to correct the falling of the light amount at the periphery of the screen by increasing an image gain to compensate for the lack of the light amount.

The second data group has a three-dimensional table structure similar to that of the first data group. Explanation of the structure of the second data group will be omitted. In this embodiment, the second data group is chromatic aberration correction data for correcting chromatic aberration, but is not limited to this.

In this embodiment, the indexes include the positions of 0% and 100%, but are not limited to these. For example, the index on the smallest aperture side may be set to the 80% position, and for positions on the smaller aperture side than 80%, the optical data at the 80% position may be referenced.

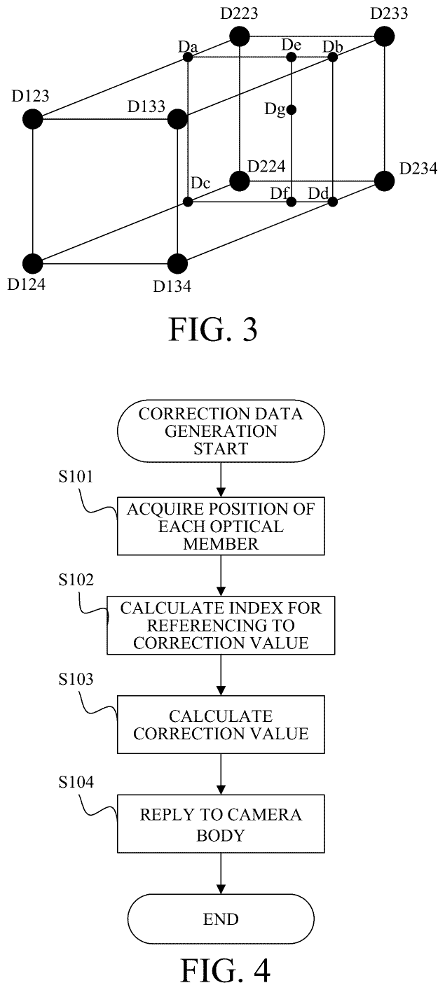

Next, an interpolation calculation process for calculating a correction value at the current position from the first data group or the second data group will be described with reference to FIG. 3. In this embodiment, an example is described in which, for the peripheral illumination correction using the first data group, a correction value at the current position is calculated in the lens apparatus 101, and for the chromatic aberration correction using the second data group, a correction value at the current position is calculated in the camera body 102. That is, this interpolation calculation is performed by the first data processing unit 1008 of the lens apparatus 101 with respect to the peripheral illumination correction, and is performed by the data generator 1103 of the camera body 102 with respect to the chromatic aberration correction. However, this embodiment is not limited to this.

FIG. 3 explains the interpolation calculation of the optical data when the diaphragm position is detected as 15%, the zoom position is detected as 70%, and the focus position is detected as 80%. In a case where the position of the diaphragm 1003 is 15%, the position is between the position 0% of the index I01 of the diaphragm 1003 and the position 25% of the index I02 of the diaphragm 1003, and I01 and I02 are calculated as the indexes of the diaphragm 1003. Similarly, for the zoom, the indexes Z02 and Z03 are calculated, and for the focus, the indexes F03and F04 are calculated.

First, the interpolation calculation is performed in a diaphragm direction for the indexes Z02 and F03. Specifically, the correction data for I01, Z02, and F03 is D123, and the correction data for I02, Z02, and F03 is D223. Here, data of Da is calculated by performing the interpolation calculation based on a ratio from the relationship between the position of the diaphragm index and the current position of the diaphragm 1003. Specifically, Da is calculated by the following equation (1).

Da=(D223−D123)/(25−0)*(15−0)+D123 (1)

Similarly, the interpolation calculation is performed in the diaphragm direction between indexes Z03 and F03, between Z02 and F04, and between Z03 and F04 to calculate data Db, Dc, and Dd, respectively.

Next, the interpolation calculation is performed in a zoom direction. The interpolation calculation itself is the same as the interpolation calculation for the diaphragm, and De and Df are calculated from Da and Db, and Dc and Dd, respectively. Finally, the interpolation calculation is performed in a focus direction. The interpolation calculation itself is the same as the interpolation calculation for the diaphragm and the zoom, and Dg is calculated from De and Df.

By such processing, it is possible to calculate the correction data Dg when the diaphragm position is detected as 15%, the zoom position is detected as 70%, and the focus position is detected as 80%.

In this manner, the correction value for the current position can be calculated from the first data group or the second data group. In this embodiment, the interpolation calculation is performed in the order of the diaphragm position, the zoom position, and the focus position, but the order is not limited to this.

Next, a flow from when the lens apparatus 101 receives a request for the correction data from the camera body 102, and returns the correction data to the camera body 102. First, an operation of the first data processing unit 1008 when the peripheral illumination correction data is requested will be described with reference to FIG. 4. FIG. 4 is a flowchart which illustrates the operation of the first data processing unit 1008 when the peripheral illumination correction data is requested. The flow in FIG. 4 starts when the peripheral illumination correction data is requested by a communication from the camera body 102.

First, in a step S101, the first data processing unit 1008 acquires the positions of the optical members from the F-position detector 1004, the Z-position detector 1005, and the I-position detector 1006, respectively. Next, in a step S102, the first data processing unit 1008 calculates an index for referencing the correction value using the first data group stored in the first memory 1007 and the position of each optical member acquired in the step S101. Specifically, the first data processing unit 1008 reads out information on the diaphragm position in the upper left diagram of FIG. 2, the zoom position in the upper middle diagram of FIG. 2, and the focus position in the upper right diagram of FIG. 2 from the first memory 1007, and calculates the index for referencing the correction value.

Next, in a step S103, the first data processing unit 1008 calculates the correction value using the first data group stored in the first memory 1007, the position of each optical member, and the index of each optical member calculated in the step S102. Specifically, the first data processing unit 1008 reads out from the first memory 1007 data of the corresponding index in the lower diagram of FIG. 2 in addition to the diaphragm position in the upper left diagram of FIG. 2, the zoom position in the upper middle diagram of FIG. 2, and the focus position in the upper right diagram of FIG. 2. Then, the first data processing unit 1008 performs the above-mentioned interpolation calculation on each piece of data read out from the first memory 1007 to calculate the correction value. Next, in a step S104, the first data processing unit 1008 transmits the correction value calculated in the step S103 to the camera body 102 via the communication unit 1011, and this flow ends.

As described above, when the peripheral illumination correction data is requested, the first data processing unit 1008 can generate the peripheral illumination correction data corresponding to the current position and transmit it to the camera body 102 via the communication unit 1011.

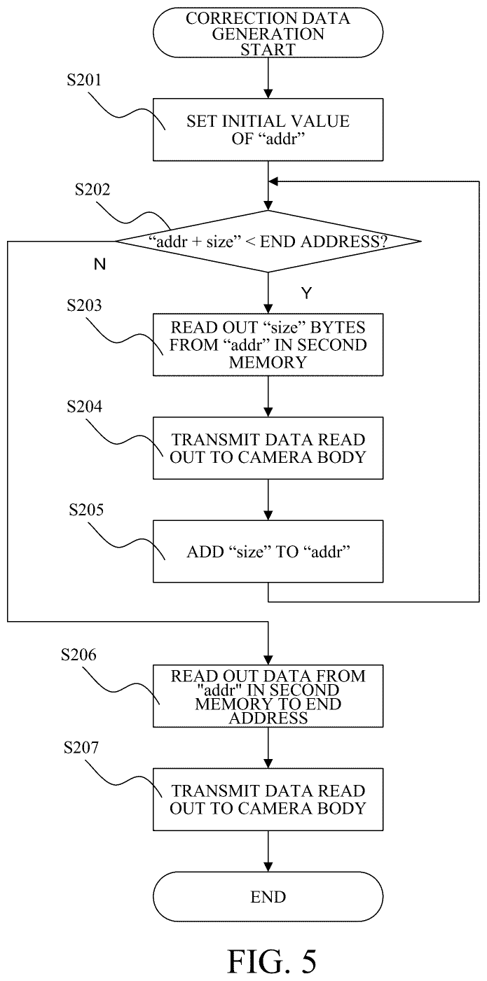

Next, an operation of the second data processing unit 1010 when the chromatic aberration correction data is requested will be described with reference to FIG. 5. FIG. 5 is a flowchart which illustrates the operation of the second data processing unit 1010. The flow in FIG. 5 is a process which is performed in response to a user operation (non-periodic process), and is started, for example, when the lens apparatus 101 is initialized (during an initialization process such as system startup). The initialization process includes not only a process which is performed when the lens apparatus 101 is turned on by a user operation, but also a process which is performed when the lens apparatus 101 returns from a power saving state, or a process which is performed when the lens apparatus 101 is connected to another external device while the power remains on.

The second data processing unit 1010 notifies the camera body 102 of all of the optical data groups illustrated in the upper left diagram to the lower diagram in FIG. 2. That is, the second data processing unit 1010 notifies the camera body 102 of all of the diaphragm position in the upper left diagram of FIG. 2, the zoom position in the upper middle diagram of FIG. 2, the focus position in the upper right diagram of FIG. 2, and the chromatic aberration correction data in the lower diagram of FIG. 2 via communication. The flowchart in FIG. 5 starts when the chromatic aberration correction data is requested from the camera body 102 via communication. Here, the beginning address of data to be read out, which is specified when the data is read out from the flash memory IC serving as the second memory 1009, is defined as “addr”, and the data size which can be read out at one time is defined as “size”.

First, in a step S201, the second data processing unit 1010 sets an initial value of the address “addr” to be read out from the second memory 1009. Specifically, the second data processing unit 1010 sets the beginning address of the optical data corresponding to the current optical unit in the second data group as the beginning address “addr”. Next, in a step S202, the second data processing unit 1010 checks the end of data by determining whether or not “addr+size” exceeds the end address of the second data group when data of the size “size” to be read out at one time is read out from “addr”. In a case where “addr+size” does not exceed the end address, the process proceeds to a step S203. On the other hand, in a case where “addr+size” exceeds the end address, the process proceeds to a step S206.

In the step S203, the second data processing unit 1010 reads out only “size” bytes from “addr” in the second memory 1009. Subsequently, in a step S204, the second data processing unit 1010 transmits the data read out in the step S203 to the camera body 102 via the communication unit 1011. Next, in a step S205, the second data processing unit 1010 adds “size” to the current “addr” and sets the added value (“addr+size”) as a new “addr” in order to set a next read-out position, and then the process returns to the step S202.

In a step S206, the second data processing unit 1010 reads out data from “addr” in the second memory 1009 to the end address of the second data group. Since the read-out size is checked in the step S202, the data size read out in the step S206 does not exceed “size”. Next, in a step S207, the second data processing unit 1010 transmits the data read out in the step S206 to the camera body 102 via the communication unit 1011, and this flow ends.

As described above, when the chromatic aberration correction data is requested, the second data processing unit 1010 can transmit a chromatic aberration correction data table corresponding to the positions of all optical members to the camera body 102 via the communication unit 1011.

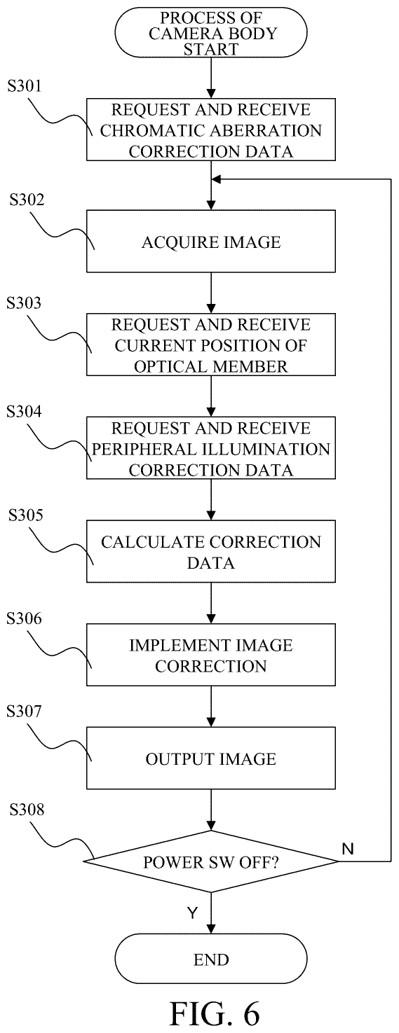

Next, an image correction process performed by the camera body 102 will be described with reference to FIG. 6. FIG. 6 is a flowchart which illustrates a process of the camera body 102. In this embodiment, a process for capturing a moving image will be described, but the present invention is not limited to this. The flow in FIG. 6 starts when a power SW (a power switch) of the camera body 102 is turned on.

First, in a step S301, the communication unit 1102 of the camera body 102 requests and receives the chromatic aberration correction data from the lens apparatus 101 as an initial communication before a start of an image capturing. Next, in a step S302, the camera body 102 captures an image using the image sensor 1101, and acquires the image. Next, in a step S303, the communication unit 1102 requests and receives from the lens apparatus 101 the current position of each optical member. Next, in a step S304, the communication unit 1102 requests and receives the peripheral illumination correction data from the lens apparatus 101.

Next, in a step S305, the data generator 1103 of the camera body 102 generates (calculates) the correction data for correcting the image based on the data received from the lens apparatus 101. Specifically, since, with regard to the peripheral illumination correction data, the data corresponding to the current position is calculated by the lens apparatus 101, the data generator 1103 applies the received data as is to the peripheral illumination correction data. On the other hand, with regard to the chromatic aberration correction data, the data generator 1103 uses the data group received in the step S301 and the current position of each optical member received in the step S303 to calculate the correction data corresponding to the current positions of the optical members using the interpolation calculation described above.

Next, in a step S306, the image processing unit 1104 of the camera body 102 corrects the image using the correction data generated in the step S305. Next, in a step S307, the image outputting unit 1105 of the camera body 102 outputs the image corrected in the step S306. Next, in a step S308, the camera body 102 determines whether or not the power SW (not illustrated) is OFF. In a case where the power SW is not OFF, the process returns to the step S302. On the other hand, in a case where the power SW is OFF, this flow ends.

As described above, the camera body 102 can output the image which has been corrected using information from the lens apparatus 101.

Next, the effects of this embodiment will be described. The process which requires reading out the first data group is the step S304 in the flowchart of FIG. 6, and is a process which occurs many times during a normal image capturing. Also, in the flowchart of FIG. 4, which starts with the request for the peripheral illumination correction data in the step S304, the process which requires reading out the first data group is the steps S102 and S103, the first data processing unit 1008 requires complex processing, such as changing the data to be read out depending on the current position of each optical member. For this reason, since the first memory 1007 in which the first data group is stored is a storage area capable of a high-speed readout, it is possible to minimize the influence caused by the speed of data readout during the normal image capturing.

On the other hand, the process which requires reading out the second data group is the step S301 in the flowchart of FIG. 6, and is only the initial communication before the normal image capturing. This process corresponds to the steps S203 and S206 in the flowchart of FIG. 5, which starts with the request for the chromatic aberration correction data in the step S301. In other words, the second data processing unit 1010 is only required to perform a simple process of sequentially reading out data from the second memory 1009 and transferring the data to the camera body 102. In addition, once the data has been read out and transferred to the camera body 102, it is not used thereafter. For this reason, the RAM area for temporarily storing the data read out from the second memory 1009 only needs to have the size of data read out at one time, making it possible to save the RAM area.

As a result, even if the second memory 1009 in which the second data group is stored is a storage area which allows only a low-speed readout, there is no influence during the normal image capturing, and the function can be realized by performing a simple data read-out process on the second memory 1009.

As described above, by appropriately arranging a storage unit which stores data in accordance with data processing required for each piece of optical data, it is possible to provide a lens apparatus which minimizes the influence on the normal image capturing caused by reading out data.

In this embodiment, the first data process is a process of generating the optical data corresponding to the position of each optical member and transmitting it to the camera, and the second data process is a process of transmitting the optical data which is not dependent om the position of each optical member to the camera, but this embodiment is not limited to these.

For example, the first data process may be a communication process which is performed during the normal image capturing, and the second data process may be a communication process which is not performed during the normal image capturing, such as an initial communication process. In this case, even if the optical data required for a communication process which is not performed during the normal image capturing is stored in a storage area which allows only a low-speed readout, the influence on the normal image capturing is limited. In addition, by storing the optical data required for a communication process which is performed during the normal image capturing in a storage unit from which the lens CPU can read out the data at high speed, it is possible to reduce the influence during the normal image capturing.

Also, for example, the first data process may be a high-speed communication process with an external device, and the second data process may be a low-speed communication process with an external device. By storing the optical data required for the high-speed communication in a storage unit which can read data at high speed, it is possible to reduce the influence on the high-speed communication process. Furthermore, even if the optical data required for the low-speed communication process is stored in a storage area which allows only a low-speed readout, the influence on the low-speed communication process is limited compared to the high-speed communication process.

Examples of the high-speed communication process with an external device and the low-speed communication process with an external device are as follows. That is, in a configuration in which a communication is performed through contacts in a mount unit which is coupled to the camera, the communication may be performed in such a way that a communication speed, a communication interval, and number of communication channels are changed according to the requirements of the camera. Specifically, in a system in which the camera body and the lens apparatus share the same communication generation and these communication speeds are increased when newer generations of these are used, it is conceivable that the optical data required for a communication used only by an older generation camera body could be stored in a storage area which allows only a low-speed readout.

Also, for example, the optical data required for a communication for high-speed transfer of the optical data, which is different from a normal communication, may be stored in a storage area which allows high-speed readout. The communication for the high-speed transfer of the optical data may be a communication which allows data intervals or byte intervals to be narrower than in the normal communication, for example, in response to a command. Alternatively, the communication for the high-speed transfer of the optical data may be a communication in which a channel different from a communication channel from the lens apparatus to the camera body, such as a communication channel from the camera body to the lens apparatus, is temporarily used for a data transfer from the lens apparatus to the camera body.

In addition, in a configuration in which a communication with an external device is possible through a camera mount and a connector separate from the camera mount, a storage location of the data used in each communication may be allocated based on the communication speed defined by each communication protocol. Specifically, in a case where the communication speed with the camera mount is faster than the communication speed with the external device, it is conceivable to store the optical data required for the communication with the camera mount in a storage area which allows a high-speed readout.

In addition, in a configuration in which a communication with multiple types of camera bodies is possible by changing the camera mount, the storage location of the data used in each communication may be allocated based on the communication speed defined by each communication protocol.

Also, for example, the first data process may be a process required for starting up or initializing the system, and the second data process may be a process required for a normal operation of the system. Specifically, initial values of the data which must be stored in RAM due to the constraints of the microcomputer are usually stored in the ROM within the microcomputer, that is, in a storage unit from which the data can be read out at high speed. However, by storing this data in a storage area which allows only a low-speed readout, it is possible to increase the free space in the ROM area within the microcomputer. The readout of this data is used only for the system startup process, and once transferred to the RAM, there is no need to read out it again. For this reason, even if the data is placed in the storage area which allows only a low-speed readout, the influence is limited.

In this embodiment, the first data group is the peripheral illumination correction data, and the second data group is the chromatic aberration correction data, but this embodiment is not limited to these. In a system in which the camera body 102 performs the interpolation calculation on the peripheral illumination correction data and the lens apparatus 101 performs the interpolation calculation on the chromatic aberration correction data, the first data group is the chromatic aberration correction data and the second data group is the peripheral illumination correction data. Moreover, the data stored in each memory may be other optical data. The data stored in each memory may be, for example, a focal length, an angle of view, a field of view, an object distance, a focus sensitivity, an entrance pupil, an exit pupil, correction values for a distortion correction, a breathing correction due to a focus change, or an image restoration, focus correction information, or any other optical data.

In addition, in this embodiment, a structure of the optical data has been described as being a table structure corresponding to the position of each optical member, but this embodiment is not limited to this. For example, the same effect can be achieved by using optical data having coefficients of an n-th degree equation corresponding to the position of each optical member. In addition, the optical data may be optical data in which the table structure corresponding to the position is used for some optical members, and the coefficients of an n-th degree equation corresponding to the position are used for other optical members.

In addition, in this embodiment, an example has been described in which the image processing is performed on the camera side during the image capturing, but this embodiment is not limited to this. For example, when a moving image is recorded on the camera side, the optical data may be embedded inside the moving image file, and the image processing may be performed by referring to the optical data in the moving image file during moving image editing such as post-production. Also, for example, in a system including an image processing apparatus which is different from the camera, the camera which acquires the optical data may transmit the optical data together with a moving image signal to the image processing apparatus, and the image processing apparatus may perform the image processing. Also, for example, the lens apparatus may be an external device different from the camera apparatus, and may transmit the optical data to the image processing apparatus, and the image processing apparatus may perform the image processing using a moving image signal acquired from the camera and the optical data acquired from the lens apparatus.

In this embodiment, the first memory 1007 is the ROM area within the microcomputer, and the second memory 1009 is the flash memory IC, but this embodiment is not limited to these. For example, the first memory 1007 or the second memory 1009 may be a data flash area inside the microcontroller where data can be rewritten, or the first memory 1007 or the second memory 1009 may be another storage device such as an EEPROM, a ROM inside a microcomputer other than the main microcomputer, an SD card, a USB memory, or other storage units. Depending on the readout speed from the main microcomputer, it can be determined whether the data is to be stored in the first memory 1007 or the second memory 1009.

In this embodiment, the first memory 1007 and the second memory 1009 are determined according to the readout speed from the main microcomputer, but this embodiment is not limited to this. For example, when a memory which can be randomly accessed and a memory which cannot be randomly accessed, are configured, using the randomly accessible memory as the first memory 1007 provides an advantage in a data access when the optical data corresponding to the position of each optical member is generated. Furthermore, even if the memory does not allow random access, the influence is limited in the process of transmitting to the camera body 102 the optical data which is independent of the position of each optical member, because a sequential data access can be performed from the beginning address of the data.

### Second Embodiment

Next, a lens apparatus according to the second embodiment will be described. In this embodiment, a method for appropriately arranging optical data in a configuration in which a relay unit within the lens apparatus is replaceable will be described.

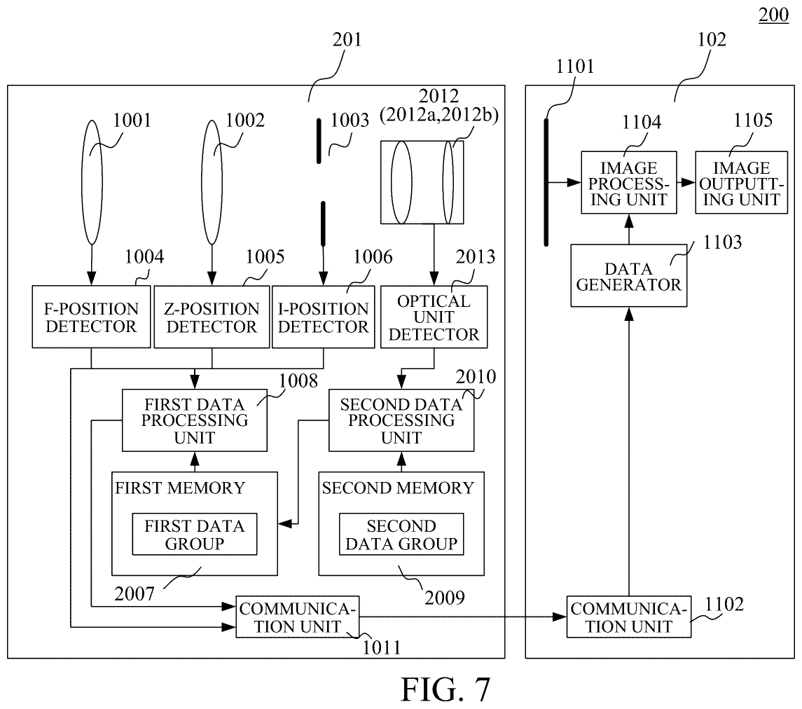

First, an image pickup system 200 according to this embodiment will be described with reference to FIG. 7. FIG. 7 is a block diagram of the image pickup system 200. The image pickup system 200 includes a camera body (am image pickup apparatus) 102 and a lens apparatus (an interchangeable lens) 201 which is detachably attachable to the camera body 102. However, this embodiment is not limited to this, and can also be applied to an image pickup apparatus in which the camera body and the lens apparatus are integrally configured. The components common to the lens apparatus 101 described in the first embodiment with reference to FIG. 1 are denoted by the same reference numerals as in FIG. 1, and the description thereof will be omitted.

The lens apparatus 201 has a first memory (a first storage unit) 2007 and a second memory (a second storage unit) 2009. The first memory 2007 is a storage unit from which data can be read out at high speed by the lens CPU which performs a lens control, and to which data can be written, as compared with the second memory 2009. In this embodiment, the first memory 2007 is a DataFlash area in a one-chip microcomputer, but is not limited to this.

The second memory 2009 is a storage unit from which data is read out by the lens CPU which performs the lens control at a lower speed than the first memory 2007. In this embodiment, the second memory 2009 is a flash memory IC which is separately configured outside the microcomputer, but is not limited to this. When data is read out from the flash memory IC, it is necessary to specify the beginning address of the data to be read out via a serial communication and a size of the data to be read out via the serial communication, and then read out the data.

The first memory 2007 stores a first data group, and the second memory 2009 stores a second data group. This is because the storage area of the first memory 2007 alone is not sufficient to store both the first data group and the second data group in the first memory 2007. The first data group and the second data group will be described in detail later.

A second data processing unit 2010 uses the data stored in the second memory 2009 to rewrite the data in the first memory 2007 in accordance with a detection result of an optical unit detector 2013 which is described later. Details of this will be described later.

An optical unit 2012 is a relay group (an accessory apparatus) which guides a light beam from the lens apparatus 201 to the camera body 102. The optical unit 2012 may be, for example, an optical unit 2012a which guides a light beam to a full frame image circle, or an optical unit 2012b which guides a light beam to a Super 35 image circle. The lens apparatus 201 is configured so that the optical unit 2012a and the optical unit 2012b are interchangeable.

The optical unit 2012b is a reduction optical system with a magnification of approximately 0.7 times that of the optical unit 2012a, and as a result, the corresponding image circle becomes smaller, making it possible to make the lens brighter. That is, since the optical characteristics differ between when the optical unit 2012a is attached and when the optical unit 2012b is attached, the optical data notified to the camera body 102 must also be different for each case. In this embodiment, the optical unit 2012 must be replaced by unscrewing a lens mount portion, that is, the replacement is possible only when the lens apparatus 201 is not powered on.

The optical unit detector (a state detector) 2013 detects whether or not the optical unit 2012 attached to the lens apparatus 201 is the optical unit 2012a for a full frame or the optical unit 2012b for Super 35. The state detector is not limited to the optical unit detector 2013 which detects a state of the optical unit 2012, but may be capable of detecting other states of the lens apparatus 201, such as a state of the mount unit.

In this embodiment, preferably, the first optical data is optical data in one state corresponding to a state of the lens apparatus 201, and the second optical data is a plurality of optical data in a plurality of states corresponding to the state of the lens apparatus 201. In addition, preferably, the first process is a process for performing a communication with an external device based on the first optical data. The second process is a process of reading out from the second memory 2009 the optical data corresponding to the state detected by the state detector, among the plurality of optical data constituting the second optical data, and storing it in the first memory 2007. Preferably, the second process is a process which is performed when the state of the state detector changes. Also preferably, the state of the lens apparatus 201 is at least one of attachment states of other accessories attached to an object side of, to an image side of, or inside the lens apparatus 201. Also preferably, the state of the lens apparatus 201 is at least one of an attachment state of an interchangeable mount portion of the lens apparatus 201 and an inserted/removed state of a magnification optical system or a reduction optical system built into the lens apparatus 201.

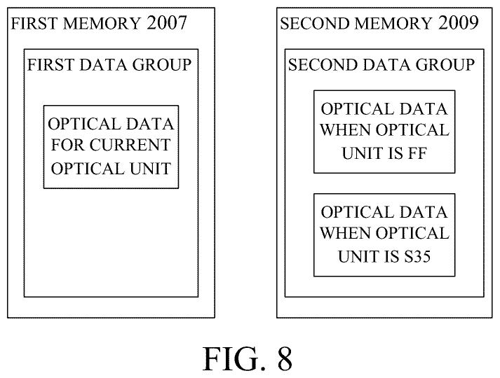

Next, the optical data (the first data group and the second data group) will be described in detail with reference to FIG. 8. FIG. 8 explains the first data group and the second data group. The second data group in this embodiment is composed of two data, as illustrated in FIG. 8, namely, the peripheral illumination correction data in a case where the optical unit 2012a for the full frame is attached, and the peripheral illumination correction data in a case where the optical unit 2012b for Super 35 is attached. The structure of each peripheral illumination correction data is the same as in the first embodiment, and therefore description thereof will be omitted.

The first data group in this embodiment is the peripheral illumination correction data for an optical unit which is currently attached to the lens apparatus 201. The first data group is rewritten by the second data processing unit 2010 in accordance with the detection result by the optical unit detector 2013. A data process by the second data processing unit 2010 will be described later.

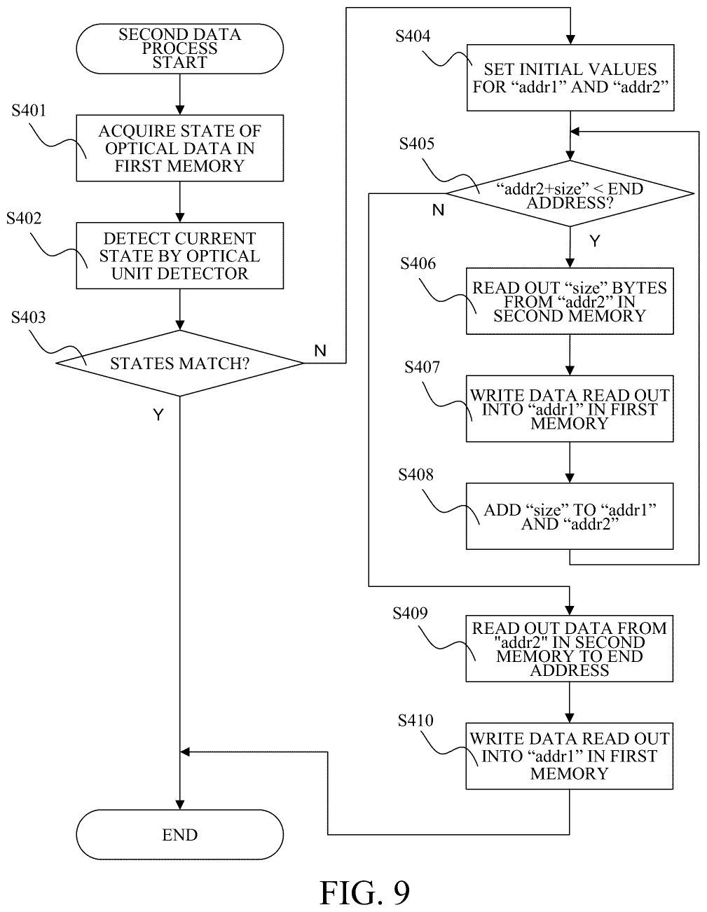

Next, the data process by the second data processing unit 2010 will be described with reference to FIG. 9. FIG. 9 is a flowchart which illustrates an operation of the second data processing unit 2010. The flow in FIG. 9 is a process which is performed when the lens apparatus 201 is powered on.

First, in a step S401, the second data processing unit 2010 acquires information indicating whether the first data group currently stored in the first memory 2007 is the optical data for the optical unit 2012a or the optical data for the optical unit 2012b. That is, the second data processing unit 2010 acquires a state of the optical data in the first memory 2007.

Next, in a step S402, the second data processing unit 2010 acquires information indicating whether the currently attached optical unit detected by the optical unit detector 2013 is the optical unit 2012a or the optical unit 2012b. That is, the second data processing unit 2010 acquires a current state detected by the optical unit detector 2013.

Next, in a step S403, the second data processing unit 2010 compares the state of the optical data currently stored in the first memory 1007 acquired in the step S401 with the state of the currently attached optical unit acquired in the step S402. In a case where these states match, this flow ends, whereas in a case where these states do not match, the process proceeds to a step S404.

In a step S404, the second data processing unit 2010 sets initial values for an address “addr1” to be written to the first memory 1007 and an address “addr2” to be read out from the second memory 1009. Specifically, the second data processing unit 2010 sets the beginning address of the first data group as “addr1”, and sets the beginning address of the optical data corresponding to the current optical unit in the second data group as “addr2”. In a case of a device which requires an erasure before writing to the first memory 2007, the erasure may be performed at this time.

Next, in a step S405, the second data processing unit 2010 checks the end of data by determining whether or not “addr2+size” exceeds the end address of the optical data corresponding to the current optical unit in the second data group when data of the size “size” to be read out at one time is read out from “addr2”. In a case where “addr2+size” does not exceed the end address, the process proceeds to a step S406. On the other hand, in a case where “addr2+size” exceeds the end address, the process proceeds to a step S409.

In the step S406, the second data processing unit 2010 reads out only “size” bytes from “addr2” in the second memory 1009. Subsequently, in a step S407, the second data processing unit 2010 writes the data read out in the step S406 into “addr1” in the first memory 2007. Next, in a step S408, the second data processing unit 2010 adds “size” to the current “addr1” and “addr2”, respectively, and sets the added values as new “addr1” and “addr2”, in order to set a next read-out position and a next write position, and then the process returns to the step S405.

In the step S409, the second data processing unit 2010 reads out data from “addr2” in the second memory 1009 to the end address of the optical data corresponding to the current optical unit in the second data group. Since the read-out size is checked in the step S405, the data size read out in the step S409 does not exceed “size”. Subsequently, in a step S410, the second data processing unit 2010 writes the data read out in the step S409 into “addr1” in the first memory 2007, and this flow ends.

As described above, the second data processing unit 1010 is capable of comparing the state of the optical data currently stored in the first memory 1007 with the state of the currently attached optical unit, and re-storing the optical data in a case where these states do not match.

Next, the effects of this embodiment will be described. The process which requires the readout of the first data group is a process which occurs many times during the normal image capturing, as in the first embodiment, and the first data processing unit 1008 requires complex processing, such as changing the data to be read out depending on the current position of each optical member.

On the other hand, the process which requires the readout of the second data group is the steps S406 and S409 in the flowchart of FIG. 9, which is a process which is performed when the power is turned on when the attachment state of the optical unit changes. In addition, the second data processing unit 1010 performs a simple process of sequentially reading out data from the second memory 1009 and storing it in the first memory 1007. In addition, data which has been read out once and stored in the first memory 1007 can be read out from the first memory 1007 thereafter. For this reason, the RAM area for temporarily storing the data read out from the second memory 1009 only needs to have the size of data read out at one time, making it possible to save the RAM area.

Therefore, even if the second memory 1009 in which the second data group is stored is a storage area which allows only a low-speed readout, an access to the second memory 1009 occurs only when the optical unit is changed, thereby minimizing the influence on a product operation. Of course, there is no influence during the normal image capturing, and the function can be realized by simply reading out data from the second memory 1009.

As described above, by appropriately arranging a storage unit which stores data in accordance with data processing required for each piece of optical data, it is possible to provide a lens apparatus which minimizes the influence on the normal image capturing caused by reading out data.

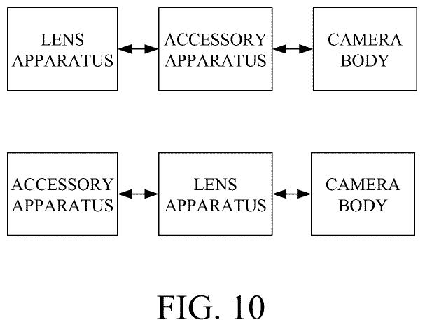

In this embodiment, the relay unit within the lens apparatus 201 is replaceable, but this embodiment is not limited to this. This embodiment can also be applied to a configuration in which an accessory apparatus such as a magnification optical system or a reduction optical system can be attached between the lens apparatus and the camera body, as illustrated in the upper diagram of FIG. 10. This embodiment can also be applied to a configuration in which an accessory apparatus such as a converter can be attached to the object side of the lens apparatus, as illustrated in the lower diagram of FIG. 10.

In addition, in this embodiment, the same effect can be achieved even in a configuration in which a built-in extender unit is insertable and removable. However, in a configuration in which the built-in extender unit can be switched during the normal image capturing, the flowchart corresponding to FIG. 9 must be performed regularly or whenever the built-in extender unit is switched.

The same effect can also be achieved in a configuration in which a lens mount is replaceable. Specifically, in a configuration in which communications with multiple types of camera bodies are possible by changing the mount, all of the optical data used in each communication can be stored in the second memory 2009. Then, the optical data to be used in the current mount state is stored in the first memory 2007, and when the state of the attached mount changes, the data in the first memory 2007 can be rewritten. Similarly, even if the optical data to be used differs depending on the model or generation of the camera body 102, it is possible to detect a change in the attached camera body 102 and perform similar processing, thereby achieving the same effect.

In this embodiment, the optical unit detector 2013 is configured to automatically detect the attached optical unit 2012, but this embodiment is not limited to this. In other words, in a case where it is difficult to configure the optical unit detector 2013 to automatically detect the optical unit 2012, the optical unit detector 2013 may be configured to have a setting unit which sets the attached optical unit, and the optical unit detector 2013 may be configured to detect the attached optical unit 2012 based on information from the setting unit.

In this embodiment, the optical data is described as correction data for which the interpolation calculation is performed on the lens side according to the current position, but this embodiment is not limited to this. For example, even if the correction data is such that the interpolation calculation is performed in the camera body as described in the first embodiment, the same effect can be obtained in a configuration in which the optical unit is replaceable.

In this embodiment, the first memory 2007 is a DataFlash area in a one-chip microcomputer, and is configured to be capable of storing data even if the power supply to the lens apparatus 201 is cut off. However, a certain degree of effect can be obtained even in an area which is not stored when the power supply to the lens apparatus 201 is cut off, such as a RAM in a one-chip microcomputer. That is, in this embodiment, only when the states do not match in the step S403 of FIG. 9, the readout is performed from the second memory 2009. On the other hand, when the RAM is used as the first memory 2007, the steps S401 and S403 need not be performed, and data can be read out from the second memory 2009 and temporarily stored in the first memory 2007 whenever the lens apparatus is powered on. That is, of the optical data stored in the second memory 2009, only the optical data to be used in the current state can be stored in the first memory 2007 which allows a high-speed readout when the power is turned on. As a result, even if the second memory 1009 in which the second data group is stored is a storage area which allows only a low-speed readout, an access to the second memory 1009 occurs only when the power is turned on, thereby minimizing the influence on a product operation.

In this embodiment, the second memory 2009 is disposed within the lens apparatus 201, and is configured to store the optical data corresponding to both optical units. However, the same effect can be achieved by disposing the second memory 2009 in the optical unit and storing in the second memory 2009 only data corresponding to the optical unit in which the second memory 2009 is disposed. Specifically, the optical unit 2012a for the full frame is provided with the second memory 2009a, which stores the peripheral illumination correction data for when the optical unit 2012a for the full frame is attached. Similarly, the optical unit 2012b for Super 35 is provided with the second memory 2009b, which stores the peripheral illumination correction data for when the optical unit 2012b for Super 35 is attached. When the optical unit is switched, the optical data is read out from the second memory 2009 disposed in the optical unit and written to the first memory 2007, thereby making it possible to prevent an access to the second memory 2009 during the normal image capturing.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that some embodiments are not limited to the disclosed embodiments. The scope of the following claims is to be accorded the broadest interpretation so as to encompass all such modifications and equivalent structures and functions.

Each embodiment can provide an accessory apparatus in which optical data is appropriately arranged in multiple storage units.

This application claims priority to Japanese Patent Application No. 2024-022893, which was filed on Feb. 19, 2024, and which is hereby incorporated by reference herein in its entirety.

What is claimed is:

1. An accessory apparatus detachably attached to an image pickup apparatus, the accessory apparatus comprising:
a processor configured to perform a first process and a second process in performing a communication with an external device;
a first storage unit; and
a second storage unit having a readout speed lower than a readout speed of the first storage unit,
wherein the first storage unit stores first optical data related to the first process, and the second storage unit stores second optical data related to the second process.

2. The accessory apparatus according to claim 1,
wherein the first process is a process which is performed in a case where a state of the accessory apparatus does not change, and
wherein the second is a process which is performed in a case where the state of the accessory apparatus changes.

3. The accessory apparatus according to claim 1,
wherein the first process is a process which is periodically performed, and
wherein the second is a process which is performed in response to a user operation.

4. The accessory apparatus according to claim 1, wherein the second process is an initialization process for the accessory apparatus.

5. The accessory apparatus according to claim 1, further comprising:
a movable optical member; and
a position detector configured to detect a current position of the optical member,
wherein the first process is a process for calculating optical data corresponding to the current position by using at least a part of the first optical data, and transmitting the optical data to the external device, and
wherein the second process is a process for transmitting the second optical data to the external device.

6. The accessory apparatus according to claim 1, further comprising:
a movable optical member; and
a position detector configured to detect a current position of the optical member,
wherein the second optical data is at least one of focal length information, angle-of-view information, field-of-view information, object distance information, focus sensitivity information, entrance pupil position information, exit pupil position information, peripheral illumination correction information, chromatic aberration correction information, distortion aberration correction information, breathing correction information due to focus change, correction information for image restoration, and focus correction information.

7. The accessory apparatus according to claim 1, further comprising:
a state detector configured to detect a state of the accessory apparatus,
wherein the first optical data is optical data in one state corresponding to the state of the accessory apparatus,
wherein the second optical data is a plurality of optical data in a plurality of states corresponding to the state of the accessory apparatus,
wherein the first process is a process for performing the communication based on the first optical data, and
wherein the second process is a process for of reading out from the second storage unit optical data corresponding to the state detected by the state detector among the plurality of optical data constituting the second optical data and storing the optical data in the first storage unit.

8. The accessory apparatus according to claim 7, wherein the second process is a process which is performed in changing the state detected by the state detector.

9. The accessory apparatus according to claim 7,
wherein the state of the accessory apparatus is at least one of attachment states of other accessories attached to an object side of, to an image side of, or inside the lens apparatus, an attachment state of an interchangeable mount portion of the lens apparatus, and an inserted/removed state of a magnification optical system or a reduction optical system built into the lens apparatus.

10. The accessory apparatus according to claim 1,
wherein the first process is a process for performing the communication at a first communication speed, and
wherein the second process is a process for performing the communication at a second communication speed which is lower than the first communication speed.

11. The accessory apparatus according to claim 1, further comprising a lens.

12. An image pickup system comprising:
an accessory apparatus according to claim 1; and
the image pickup apparatus including an image sensor.

13. A control method of an accessory apparatus detachably attached to an image pickup apparatus, the control method comprising:
a first step of performing a communication with an external device through a first process; and
a second step of performing the communication with the external device through a second process,
wherein in the first step, acquiring first optical data from a first storage unit, and performing the first process by using the first optical data, and
wherein in the second step, acquiring second optical data from a second storage unit having a readout speed lower than a readout speed of the first storage unit, and performing the second process by using the second optical data.

14. A non-transitory computer-readable storage medium storing a computer program that causes a computer to execute the control method of the accessory apparatus according to claim 13.
